(19) United States
(12) Patent Application Publication
(10) Pub. No.: US 2026/0273413 A1
(43) Pub. Date: Sep. 17, 2026

(54) Interface Display Method and Apparatus, Device, and Storage Medium

(71) Applicant: Tencent Technology (Shenzhen) Company Limited, Shenzhen (CN)

(72) Inventors: Jinhao Yang, Shenzhen (CN); Lingyun Lin, Shenzhen (CN)

(21) Appl. No.: 19/671,527

(22) Filed: May 8, 2026

Related U.S. Application Data
(63) Continuation of application No. PCT/CN2025/101666, filed on Jun. 18, 2025.

(30) Foreign Application Priority Data
Aug. 2, 2024 (CN) 202411058154.6

(51) Int. Cl. A63F 13/577; A63F 13/533; A63F 13/54; A63F 13/837

(52) U.S. Cl. CPC A63F 13/577; A63F 13/533; A63F 13/54; A63F 13/837

(57) ABSTRACT

An interface display method and apparatus, a device, and a storage medium, relating to the field of computer technologies is provided. The method and apparatus provide for displaying a virtual environment, where the virtual environment including a virtual shooting prop) and detecting interaction with the virtual shooting prop. In response to detecting the operation on the virtual shooting prop, the method and apparatus provide for controlling the virtual shooting prop to release at least one projectile into the virtual environment. When a first projectile among the at least one projectile collides with a virtual item in the virtual environment, and the virtual item satisfies a ricochet condition, a ricochet effect of the first projectile on the virtual item is generated and displayed. The ricochet condition may be a condition for generating the ricochet effect. The foregoing approach enriches forms of human-computer interaction.

### RELATED APPLICATION

This application is a continuation of PCT Application No. PCT/CN2025/101666, entitled “INTERFACE DISPLAY METHOD AND APPARATUS, DEVICE, AND STORAGE MEDIUM” and filed on Jun. 18, 2025, and claims priority to Chinese Patent Application No. 202411058154.6, entitled “INTERFACE DISPLAY METHOD AND APPARATUS, DEVICE, AND STORAGE MEDIUM” filed on Aug. 2, 2024, the contents of which are incorporated herein by reference in their entirety.

### TECHNICAL FIELD

This application relates to the field of computer technologies, and in particular, to an interface display method and apparatus, a device, and a storage medium.

### BACKGROUND

In a game, virtual shooting props are usually used to attack virtual objects having virtual roles of other camps, to achieve victory in the game.

In the related technology, if a projectile released by a virtual shooting prop does not hit a virtual role of another camp but accidentally collides with a virtual item in a virtual environment, an animation of the projectile hitting the virtual item is usually directly displayed.

In the foregoing related technology, the animation of the projectile hitting the virtual item is directly displayed, leading to a limited form of human-computer interaction.

### SUMMARY

Aspects described herein provide an interface display method and apparatus, a device, and a storage medium, which can enrich forms of human-computer interaction and improve efficiency of human-computer interaction. Technical solutions provided by this application include at least the following aspects.

According to one or more aspects, an interface display method is provided, the method being performed by a terminal device, and the method including the following operations:
displaying a virtual environment, the virtual environment including a virtual shooting prop;
controlling, in response to an operation on the virtual shooting prop, the virtual shooting prop to release at least one projectile into the virtual environment; and
displaying, when a first projectile among the at least one projectile collides with a virtual item in the virtual environment, and the virtual item satisfies a ricochet condition, a ricochet effect of the first projectile generated on the virtual item, the ricochet condition being a condition for generating the ricochet effect.

According to further aspects, an interface display apparatus is provided, the apparatus including the following modules:
a display module, configured to display a virtual environment, the virtual environment including a virtual shooting prop;
a control module, configured to control, in response to an operation on the virtual shooting prop, the virtual shooting prop to release at least one projectile into the virtual environment; and
a ricochet module, configured to display, when a first projectile among the at least one projectile collides with a virtual item in the virtual environment, and the virtual item satisfies a ricochet condition, a ricochet effect of the first projectile generated on the virtual item, the ricochet condition being a condition for generating the ricochet effect.

According to still other aspects, a terminal device is provided, the terminal device including a processor and a memory, the memory having a computer program stored therein, and the computer program being loaded and executed by the processor to implement the foregoing interface display method.

According to other aspects, a computer-readable storage medium is provided, the computer-readable storage medium having a computer program stored therein, and the computer program being loaded and executed by a processor to implement the foregoing interface display method.

According to one or more aspects, a computer program product is provided, the computer program product including a computer program, and the computer program being loaded and executed by a processor to implement the foregoing interface display method.

Aspects described herein may provide the following beneficial effects.

A new ricochet mechanism design is provided. When the virtual shooting prop is controlled to release the at least one projectile into the virtual environment, if the first projectile among the at least one projectile collides with the virtual item in the virtual environment, and the virtual item meets the ricochet condition, the ricochet effect of the first projectile generated on the virtual item is generated and displayed.

In comparison with related existing technology in which an animation of the first projectile hitting the virtual item is directly displayed (i.e., displayed as a final disposition of the first projectile), in this application, a ricochet mechanism is triggered when the virtual item satisfies the ricochet condition. This triggers the generation of the ricochet effect of the first projectile against the virtual item, not only enriching the forms of human-computer interaction, but also using the ricochet effect to indicate a collision between the first projectile and the virtual item. Furthermore, the virtual item satisfies the ricochet condition, which improves information transparency, thereby improving efficiency of human-computer interaction.

In addition, when the at least one projectile collides with the virtual item in the virtual environment, and the virtual item satisfies the ricochet condition, the ricochet effect of the first projectile generated on the virtual item can be displayed, so that the ricochet mechanism is difficult to predict to some extent, which can provide a sense of novelty and excitement for users in the game. Further, by displaying the ricochet effect of a projectile generated on the virtual item, a shooting effect approximating that of a real shooting prop can be achieved, thereby helping improve game experience of the users.

### BRIEF DESCRIPTION OF THE DRAWINGS

FIG. 1 is a schematic diagram of an example computer system according to one or more aspects described herein.

FIG. 2 is a schematic diagram of an interface display method according to one or more aspects described herein.

FIG. 3 is a flowchart of an example interface display method according to one or more aspects described herein.

FIG. 4 is a flowchart of another example interface display method according to one or more aspects described herein.

FIG. 5 is a flowchart of another example interface display method according to one or more aspects described herein.

FIG. 6 is a schematic diagram of an example functional relationship between a scaling factor and an incident angle in different materials according to one or more aspects described herein.

FIG. 7 is a schematic diagram of an example projectile according to one or more aspects described herein.

FIG. 8 is a block diagram of a decision method for generating a ricochet effect according to one or more aspects described herein.

FIG. 9 is a block diagram of an example determination method for a reflection angle according to one or more aspects described herein.

FIG. 10 is a block diagram of an example interface display apparatus according to one or more aspects described herein.

FIG. 11 is a structural block diagram of an example terminal device according to one or more aspects described herein.

### DETAILED DESCRIPTION

First, some of the terms used herein are briefly introduced.

Virtual environment: A virtual environment may refer to an environment displayed (or provided) when an application program runs on a terminal. The virtual environment may be a simulated world of a real world, may be a semi-simulated and semi-fictional three-dimensional world, or may be a purely fictional three-dimensional world. The virtual environment may be any one of a two-dimensional virtual environment, a 2.5-dimensional virtual environment, or a three-dimensional virtual environment. In one or more arrangements, the virtual environment may be further configured for a virtual environment battle between at least two virtual objects, and the virtual environment contains virtual resources for use by the at least two virtual objects. In one example, the virtual environment includes symmetrical lower-left and upper-right regions, virtual objects belonging to two opposing camps respectively occupy one of the regions, with a victory condition of destroying a target building/fort/base/crystal deep in a region of an opposite party.

Virtual object: A virtual object may refer to at least one of a virtual role, a virtual vehicle, or a virtual item controlled by a user account in a target application program. These examples are not limiting. Using an example in which the target application program is a game application program, the virtual object is a virtual role controlled by a user account in the game application program. The virtual object may be in a form of a character, may be an animal, a cartoon, or another form. These examples are not limiting. The virtual object may be displayed in a three-dimensional form, or may be displayed in a two-dimensional form. This example is not limiting. According to one or more aspects, when the virtual environment is a three-dimensional virtual environment, the virtual object is a three-dimensional model created based on an animation skeleton technology. Each virtual object has a shape and a volume in the three-dimensional virtual environment, and occupies some space in the three-dimensional virtual environment. An activity of the virtual object includes, but is not limited to, at least one of adjusting a body posture, crawling, walking, running, riding, flying, jumping, driving, picking, shooting, attacking, or throwing. For example, the virtual object is a virtual character, such as a simulated character role or an anime character role. In some arrangements, the virtual object may alternatively be implemented by using a 2.5-dimensional model or a two-dimensional model. Aspects described herein are not limited to such an arrangement. For example, based on different methods of controlling the virtual object, virtual objects may be divided into a user-controlled virtual object and a server-controlled virtual object. The user-controlled virtual object is an object that is controlled by a client and movable in the virtual environment. The server-controlled virtual object is a virtual object controlled by an automatic control algorithm or an artificial intelligence program on the client or the server. The server-controlled virtual object includes a movable object and an immovable object in the virtual environment. For example, the immovable object can respond to or affect an activity of the movable object. For example, the movable object can destroy the immovable object, or the movable object enters a stealth state when the movable object enters the immovable object. For example, a first virtual role in this application is a virtual object controlled by the client. For example, a second virtual role in this application may be a virtual object controlled by another client or server.

User interface (UI) control: A user interface control may refer to any visible control or element, for example, a control such as a picture, an input box, a text box, a button, or a label, that can be seen on a UI of the application program. Some UI controls respond to a user operation, for example, an attack control is configured to control a virtual shooting prop to release a projectile. A user triggers the attack control to control the virtual shooting prop to release the projectile. The UI control includes, but is not limited to, the attack control.

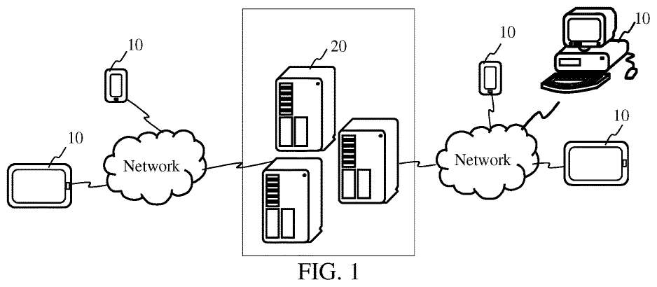

Referring to FIG. 1, FIG. 1 is a schematic diagram of an example computer system according to one or more aspects described herein. The computer system may include a terminal device 10 and a server 20.

The terminal device 10 includes, but is not limited to, an electronic device such as a mobile phone, a tablet computer, an intelligent voice interaction device, a game console, a wearable device, a multimedia playback device, a personal computer (PC), an in-vehicle terminal, or a smart appliance. A client of a target application program may be installed in the terminal device 10. In one example, the target application program may be an application program that needs to be downloaded and installed, or may be a click-to-run application program. Aspects described herein are not limited to such examples.

According to some aspects, the target application program is an application program providing a virtual prop. For example, the target application program may be any one of a simulation program, a shooting game, a virtual reality (VR) application program, an augmented reality (AR) program, a three-dimensional map program, a VR game, an AR game, a first-person shooting game (FPS), a multiplayer shooter survival game, a third-person shooting game (TPS), a multiplayer online battle arena game (MOBA), a simulation game (SLG), a social application program, and an interactive entertainment application program. In some arrangements, the target application program is provided with a virtual shooting prop, and the virtual shooting prop is controlled, in response to an operation on the virtual shooting prop, to release at least one projectile into a virtual environment. When a first projectile among the at least one projectile collides with a virtual item in the virtual environment, and the virtual item satisfies a ricochet condition, a ricochet effect of the first projectile generated on the virtual item is generated and displayed. The ricochet condition may be a condition for generating the ricochet effect. In addition, different application programs provide different virtual shooting props and ricochet conditions. Aspects described herein are not limited to such an arrangement. The following descriptions uses an example in which the target application program is a game application program, and, additionally or alternatively, the client of the target application program runs on the terminal device 10.

The foregoing virtual environment is a scenario generated and displayed (or provided) when the client of the target application program (for example, the game application program) runs on the terminal device, and the virtual environment is a scenario, such as a virtual house, a virtual island, or a virtual map, created for a virtual object to engage in an activity (for example, a game competition). The virtual environment may be a simulated environment of a real world, may be a semi-simulated and semi-fictional environment, or may be a purely fictional environment. The virtual environment may be a two-dimensional virtual environment, a 2.5-dimensional virtual environment, or a three-dimensional virtual environment. Aspects described herein are not limited to such examples. The virtual environment includes a first virtual role and a second virtual role. The virtual environment may also include additional virtual objects as desired or needed. Accordingly, the number of roles is not limited to the aforementioned examples.

The virtual object may refer to at least one of a virtual role (e.g., virtual character or other object having a particular role), a virtual vehicle, or a virtual item controlled by a user account in the target application program, but is not limited to such examples. Using an example in which the target application program is the game application program, the virtual role is a game role controlled by the user account in the game application program. The virtual role may be in a form of a character, may be an animal, a cartoon, or another form. These examples are not limiting. For example, the first virtual role and the second virtual role in this application may be both virtual roles controlled by the client. In another example, the first virtual role in this application is a virtual role controlled by the client, and the second virtual role may alternatively be a virtual role controlled by the server.

The server 20 is configured to provide a background service for the client of the target application program in the terminal device 10. For example, the server 20 may be an independent physical server, or may be a server cluster or a distributed system including a plurality of physical servers, or may be a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform like, but is not limited thereto.

In some aspects, the terminal device 10 includes a first terminal device and a second terminal device, where a first client of the target application program is installed on the first terminal device, a second client of the target application program is installed on the second terminal device, a first user controls the first virtual role (which may also be referred to as a main control virtual role) in the first client of the target application program by using a first user account, and a second user controls the second virtual role in the second client of the target application program by using a second user account. In addition to belonging to a user-controlled virtual role, the second virtual role in some examples may alternatively belong to a server-controlled virtual role (an artificial intelligence virtual role). In one arrangement, the first virtual role and the second virtual role are in the same virtual environment. Additionally or alternatively, the first virtual role and the second virtual role may belong to the same camp, the same team, or the same organization, have a friendly relationship, or have a temporary communication permission. In this case, the second virtual role is considered as a friend virtual role of the first virtual role. In another example, the first virtual role and the second virtual role may belong to different camps, different teams, or different organizations, or have an adversarial relationship. In this case, the second virtual role is considered as an enemy virtual role of the first virtual role. In one arrangement, clients installed on the first terminal device and the second terminal device are the same, or the clients installed on the two terminals are the same type of client on different operating system platforms (Android or iOS). The first terminal device may generally refer to one of a plurality of terminal devices, and the second terminal device may generally refer to another one of the plurality of terminal devices. The above description of using only the first terminal device and the second terminal device is only an example, and other terminal devices and/or numbers of terminal devices may be used or otherwise included as part of the system and process.

The terminal device 10 may communicate with the server 20 by using a network. The network may be a wired network, or may be a wireless network.

To address an issue of limited interaction caused by an absence of a ricochet effect in the existing related technology, according to aspects described herein, a ricochet effect is generated when it is determined that a ricochet condition is satisfied, thereby enriching forms of human-computer interaction.

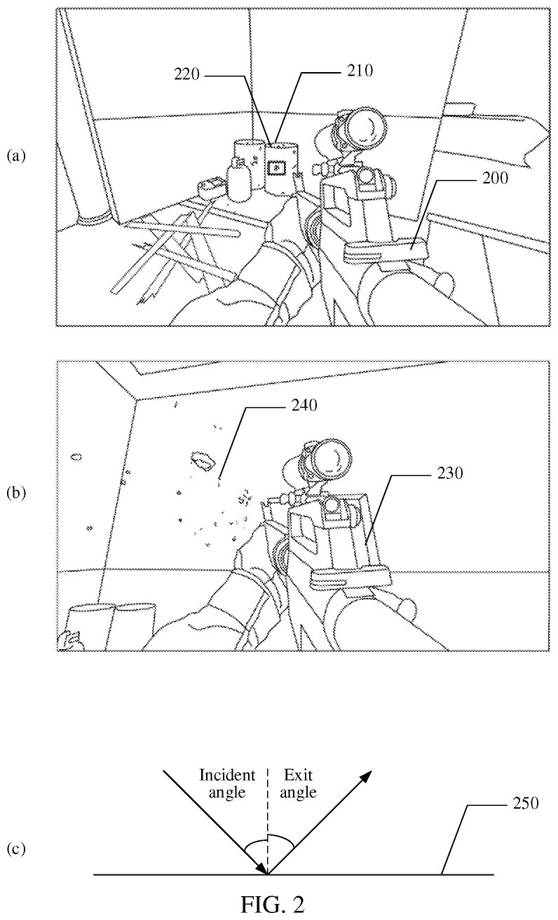

Specifically, as shown in sub-figure (a) of FIG. 2, in a virtual environment, a virtual shooting prop 200 is controlled to release a projectile. By using an example in which a virtual item in the virtual environment includes a virtual wooden barrel 210, when the projectile (not shown in the figure) collides with the virtual wooden barrel 210 at a collision point 220, and the virtual wooden barrel 210 satisfies a ricochet condition, a ricochet effect of the projectile generated on the virtual wooden barrel 210 is displayed. For example, imagery of a projectile ricocheted (or rebounded) by the virtual wooden barrel 210 is generated and displayed.

As shown in sub-figure (b) of FIG. 2, in a virtual environment, a virtual shooting prop 230 is controlled to release a projectile. By using an example in which a virtual item in the virtual environment includes a virtual wall, when the projectile (not shown in the figure) collides with the virtual wall at a collision point 240, and the virtual wall satisfies a ricochet condition, a ricochet effect of the projectile generated on the virtual wall is displayed. For example, imagery of a projectile ricocheted (or rebounded) by the virtual wall is generated and displayed.

As shown in sub-figure (c) of FIG. 2, an exit angle of a projectile after the projectile is rebounded is equal to an incident angle at which the projectile collides with a virtual item 250. The incident angle is an included angle between a motion direction of the projectile and a normal direction of the virtual item 250 at a collision point, and the exit angle is an angle between a motion direction of the rebounded projectile and the normal direction of the virtual item 250 at the collision point.

In comparison with the related existing technology in which an animation of the first projectile hitting the virtual item is directly displayed (e.g., where the first projectile's final disposition is colliding with the virtual item, without ricochet), in one or more aspects described herein, when the ricochet condition is satisfied, the ricochet effect of the projectile generated on the virtual item is displayed. Therefore, aspects described herein enrich forms of human-computer interaction. Further, by displaying the ricochet effect of the projectile generated on the virtual item, a shooting effect approximating that of a real shooting prop can be achieved, thereby helping improve game experience of users.

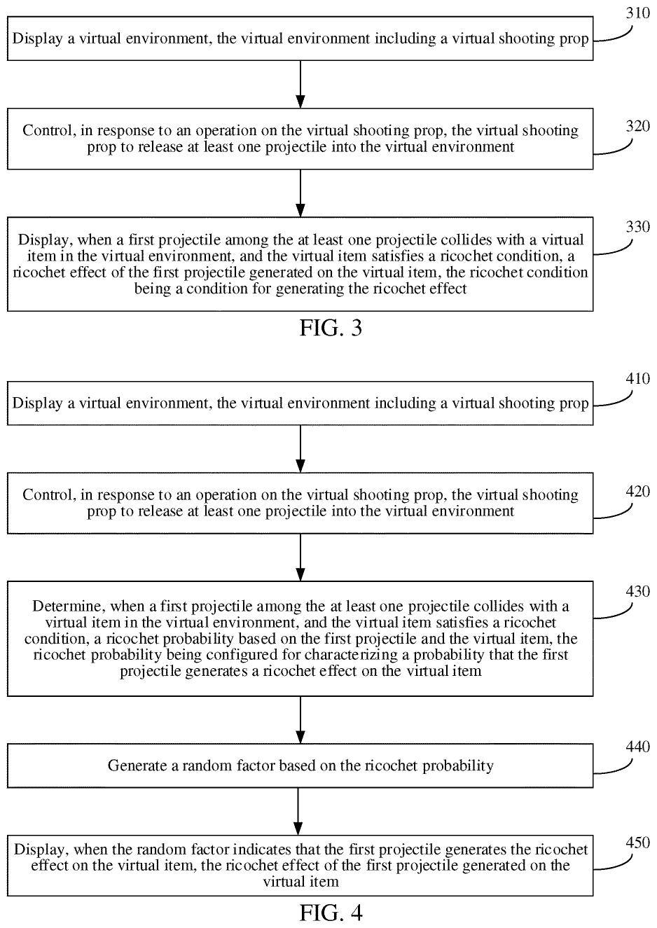

Referring to FIG. 3, FIG. 3 is a flowchart of an example interface display method according to one or more aspects described herein. Operations of the method may be executed by the terminal device 10 in the solution implementation environment shown in FIG. 1. For example, the operations may be executed by the client of the target application program. For ease of description, only an example in which the operations are executed by a “client” is used for the following description. The method may include at least one of the following operations (310 to 330):

Operation 310: Display a virtual environment, the virtual environment including a virtual shooting prop.

According to one or more aspects, a presentation picture of the virtual environment may be displayed on a terminal device in at least three manners. The first type is a first-person perspective. For example, a virtual camera is mounted on a head of a first virtual role, and a picture obtained by observing the virtual environment by the virtual camera is used as a displayed presentation picture of the virtual environment. In this case, the displayed picture of the virtual environment does not include the first virtual role. The second type is a third-person perspective. For example, a virtual camera is mounted behind the first virtual role, and a picture obtained by observing the virtual environment by the virtual camera is used as a displayed picture of the virtual environment. In this case, the displayed picture of the virtual environment may include part or all of the first virtual role. An orientation of the first-person perspective and an orientation of the third-person perspective both change with an orientation of the first virtual role. The third type is another perspective having a specific direction, and an orientation of the perspective does not change. For example, a picture obtained by observing the entire virtual environment in a specific orientation by the virtual camera is used as a displayed presentation picture of the virtual environment. In this case, the first virtual role may be displayed in the middle of the picture of the virtual environment, may be displayed at another position in the picture of the virtual environment, or is not displayed in the presentation picture of the virtual environment. Aspects described herein are not limited to such arrangements.

In some examples, the virtual environment includes the virtual shooting prop. The virtual shooting prop, as one of virtual props, has a function of releasing a projectile. The projectile is a virtual article emitted by the virtual shooting prop, or is considered as a virtual article belonging to the virtual shooting prop or a virtual article applied to the virtual shooting prop. A type of the virtual shooting prop is not limited to such examples. The virtual shooting prop includes but is not limited to at least one of a virtual catapult, a virtual crossbow, or a virtual slingshot. The projectile includes but is not limited to at least one of a virtual stone, a virtual arrow, or a virtual pellet.

In some arrangements, the virtual shooting prop is a virtual prop held by the first virtual role. In some examples, the first virtual role needs to hold the virtual shooting prop to use the virtual shooting prop. In other examples, the first virtual role can use the virtual shooting prop without a need to hold the virtual shooting prop.

Operation 320: Control, in response to an operation on the virtual shooting prop, the virtual shooting prop to release at least one projectile into the virtual environment.

In some arrangements, the projectile is the virtual article emitted by the virtual shooting prop, or is considered as the virtual article belonging to the virtual shooting prop or the virtual article applied to the virtual shooting prop. For example, the projectile needs to be used in combination with the virtual shooting prop, and cannot be used alone. In one example, if the virtual shooting prop is the virtual catapult, the projectile is the virtual stone for the virtual catapult. For example, if the virtual shooting prop is the virtual crossbow, the projectile is the virtual arrow for the virtual crossbow. In another example, if the virtual shooting prop is the virtual slingshot, the projectile is the virtual pellet for the virtual slingshot.

According to one or more aspects, the operation on the virtual shooting prop is considered as an operation of controlling the virtual shooting prop to release the at least one projectile into the virtual environment. For example, the operation on the virtual shooting prop is considered as an operation on an attack control. In some examples, an operation type of the operation on the attack control includes, but is not limited to, at least one of a click/tap operation, a long-press operation, a double-click/tap operation, a gesture operation, or a slide operation.

In some arrangements, for one operation on the virtual shooting prop, the virtual shooting prop is correspondingly controlled to release N projectiles into the virtual environment, and Nis a positive integer. For example, based on the operation type of the operation on the virtual shooting prop, the virtual shooting prop is controlled to release different quantities of projectiles. In one example, in response to one operation on the virtual shooting prop, the virtual shooting prop is controlled to release one projectile. In another example, in response to one operation on the virtual shooting prop, the virtual shooting prop is controlled to release a plurality of projectiles. Such examples are non-limiting.

Operation 330: Display, when a first projectile among the at least one projectile collides with a virtual item in the virtual environment, and the virtual item satisfies a ricochet condition, a ricochet effect of the first projectile generated on the virtual item, the ricochet condition being a condition for generating the ricochet effect.

In some arrangements, the first projectile is any projectile among the at least one projectile. In some examples, when a position of a model of the first projectile in the virtual environment overlaps with a position of a model of the virtual item in the virtual environment, it is considered that the first projectile collides with the virtual item in the virtual environment. Additionally or alternatively, when a minimum bounding box of the model of the first projectile in the virtual environment overlaps with a minimum bounding box of the model of the virtual item in the virtual environment, it is considered that the first projectile collides with the virtual item in the virtual environment.

A position at which the first projectile collides with the virtual item is not limited to the examples described herein, and the collision position is also referred to as a collision point. In some arrangements, the collision point may be any position on a surface of the virtual item. In other words, the first projectile may collide with the virtual item at any position on the surface of the virtual item. As a virtual object in the virtual environment, the virtual item is not limited to a specific category, and the virtual item may be at least one of virtual ground, a virtual wall, or a virtual desk.

In some aspects, when the first projectile collides with the virtual item, an included angle between a motion direction of the first projectile and a normal direction of the virtual item at the collision point is considered as an incident angle of the first projectile. In some arrangements, when the first projectile collides with the virtual item, if a movement track of the first projectile is not a straight line, an included angle between an instantaneous velocity direction of the first projectile at a moment of imminent collision and the normal direction of the virtual item at the collision point is considered as the incident angle of the first projectile. In some examples, when the first projectile collides with the virtual item, if the movement track of the first projectile is a linear direction, an included angle between a projection direction of the first projectile and the normal direction of the virtual item at the collision point is considered as the incident angle of the first projectile.

According to one or more aspects, the ricochet condition is the condition for generating the ricochet effect. The ricochet effect may be an electronic animation or a special effect showing rebounding of the projectile against the colliding object or surface, to highlight an effect that the projectile bounces off. For example, when the projectile triggers a ricochet, the projectile bounces off, which is accompanied by an additional spark or explosion effect, to highlight the effect that the projectile bounces off, thereby heightening a game atmosphere. Specific content of the ricochet condition is not limited to such examples, and the ricochet condition may be set by a player, or may be set by a developer in advance. When the ricochet condition is set by the player, a ricochet condition setting panel is displayed. In response to a setting operation on the ricochet condition, different ricochet conditions can be set on the ricochet condition setting panel.

When the ricochet condition is only set for the virtual item, if the first projectile among the at least one projectile collides with the virtual item in the virtual environment, and the virtual item satisfies the ricochet condition, the ricochet effect of the first projectile generated on the virtual item is displayed, the ricochet condition being the condition for generating the ricochet effect.

When the ricochet condition is only set for the projectile, if the first projectile among the at least one projectile collides with the virtual item in the virtual environment, and the projectile satisfies the ricochet condition, the ricochet effect of the first projectile generated on or against the virtual item is displayed, the ricochet condition being the condition for generating the ricochet effect.

When the ricochet condition is set for both the projectile and the virtual item, if the first projectile among the at least one projectile collides with the virtual item in the virtual environment, and the virtual item and the projectile satisfy the ricochet condition, the ricochet effect of the first projectile generated on the virtual item is displayed, the first ricochet condition being the condition for generating the ricochet effect.

The following first describes the ricochet effect of the first projectile generated on the virtual item.

According to one or more aspects, the ricochet effect of the first projectile generated on the virtual item is that the first projectile ricochets off the virtual item. For example, ricocheting may also be understood as rebounding. When the first projectile collides with the virtual item at the incident angle, the first projectile is rebounded at the collision point. For example, an included angle between a motion direction of the first projectile after ricocheting and the normal direction of the virtual item at the collision point is considered as an exit angle of the first projectile. In another example, an included angle between an instantaneous velocity direction of the first projectile after ricocheting and the normal direction of the virtual item at the collision point is considered as the exit angle of the first projectile.

In some arrangements, the exit angle is equal to the incident angle. In other arrangements, the exit angle is greater than the incident angle.

The following describes ricochet conditions.

In one or more arrangements, the ricochet condition includes at least one of the following: a material of the virtual item belongs to a material of a specified category; a quantity of ricochets of the first projectile is less than a specified quantity; the virtual environment belongs to a virtual environment of a specified category; or the virtual shooting prop belongs to a virtual shooting prop of a specified category.

In some examples, the material of the virtual item belongs to the material of the specified category. In one example, the material of the specified category is a bouncy material. In some arrangements, the bouncy material is a material that allows the projectile to ricochet. Additionally or alternatively, materials for different virtual items are different. Some categories of materials are bouncy materials, and some categories of materials are not bouncy materials. Table 1 shows various examples materials.

TABLE 1
Various materials

| | | | | | | | | | |
|---|---|---|---|---|---|---|---|---|---|
| Concrete | Dirt | Glass | Grass | Gravel | Mud | Sand | WoodSolid | MetalSolid | Water |
| Concrete | Dirt | Glass | Grass | Gravel | Mud | Sand | Wood | Metal | Water |

As shown in Table 1, concrete, metal, dirt, and wood belong to the bouncy material, and the rest are non-bouncy materials. In this arrangement, concrete, metal, dirt, and wood belong to the material of the specified category, that is, the bouncy material, and glass, grass, gravel, mud, sand, and water belong to the non-bouncy material. According to one or more aspects, the material of the virtual item is obtained, and is compared with the material of the specified category. If the material of the virtual item belongs to the material of the specified category, it is considered that the first projectile is allowed to ricochet.

In some arrangements, the quantity of ricochets of the first projectile is less than the specified quantity.

According to one or more aspects, the specified quantity may also be understood as a maximum quantity of ricochets of the first projectile. For example, that the first projectile generates the ricochet effect on the virtual item is considered to cause a ricochet.

Additionally or alternatively, when virtual shooting props, virtual environments, and virtual items are different, specified quantities for different projectiles are different. In some arrangements, the specified quantity herein is a quantity that is set in advance, and can be set based on actual technical requirements.

According to one or more aspects, the first projectile may be a projectile that has ricocheted, or may be a projectile that has not ricocheted. This is not limited in this application.

According to some aspects, the quantity of ricochets of the first projectile is obtained, and is compared with the specified quantity of first projectile. If the quantity of ricochets of the first projectile is less than the specified quantity, it is considered that the first projectile is allowed to ricochet.

In some arrangements, the virtual environment belongs to a virtual environment of a specified category.

For example, the virtual environment of the specified category may also be understood as a virtual environment allowing generation of the ricochet effect. In some arrangements, at least one virtual environment allowing the ricochet effect is set in advance. For example, the virtual environment of the specified category includes, but is not limited to, at least one of a virtual desert, a virtual forest, or a virtual grassland. Additionally or alternatively, the virtual environment in which the virtual item is located is obtained, and is compared with the virtual environment of the specified category. When the virtual environment in which the virtual item is located belongs to the virtual environment of the specified category, it is considered that the first projectile is allowed to ricochet.

In some arrangements, the virtual shooting prop belongs to a virtual shooting prop of a specified category.

For example, the virtual shooting prop of the specified category may also be understood as a virtual shooting prop allowing the ricochet effect to be generated or produced. In some arrangements, at least one virtual shooting prop allowing the ricochet effect is set in advance. For example, the virtual shooting prop of the specified category includes, but is not limited to, at least one of the virtual catapult, the virtual crossbow, or the virtual slingshot. According to one or more aspects, a category of the virtual shooting prop is obtained, and the virtual shooting prop is compared with the virtual shooting prop of the specified category. When the virtual shooting prop belongs to the virtual shooting prop of the specified category, it is considered that the first projectile is allowed to ricochet.

In some arrangements, when a third projectile among the at least one projectile does not collide with the virtual item in the virtual environment, and the third projectile does not generate a ricochet effect on the virtual item.

According some aspects, when the third projectile among the at least one projectile collides with the virtual item in the virtual environment, but the virtual item does not satisfy the ricochet condition, the third projectile collides with the virtual item, but the third projectile does not generate the ricochet effect on the virtual item. A picture of the third projectile colliding with the virtual item is displayed, or a picture of the third projectile hitting the virtual item but not ricocheting is displayed.

In comparison with the related existing technology in which an animation of the first projectile hitting the virtual item is directly displayed, according to one or more aspects described herein, when the ricochet condition is satisfied, the ricochet effect of the projectile generated on the virtual item is displayed, thereby enriching forms of human-computer interaction.

Further, by displaying the ricochet effect of the projectile generated on the virtual item, a shooting effect approximating that of a real shooting prop can be achieved, thereby helping improve game experience of users.

Referring to FIG. 4, FIG. 4 is a flowchart of another example interface display method according to one or more aspects described herein. The method may be executed by the terminal device 10 introduced above. For example, operations are executed by the client of the target application program described herein. For ease of description, the following description uses only an example in which the operations are executed by a “client” is used for description. The method may include at least one of the following operations (410 to 450):

Operation 410: Display a virtual environment, the virtual environment including a virtual shooting prop.

Operation 420: Control, in response to an operation on the virtual shooting prop, the virtual shooting prop to release at least one projectile into the virtual environment.

Operation 430: Determine, when a first projectile among the at least one projectile collides with a virtual item in the virtual environment, and the virtual item satisfies a ricochet condition, a ricochet probability based on the first projectile and the virtual item, the ricochet probability being configured for characterizing a probability that the first projectile generates a ricochet effect on the virtual item.

In some arrangements, even if the first projectile among the at least one projectile collides with the virtual item in the virtual environment, and the virtual item satisfies the ricochet condition, a ricochet might not be 100% guaranteed. Similarly, the ricochet probability also needs to be determined based on at least one of an incident angle, a material category of a specific virtual item, a category of the projectile, or a category of the virtual shooting prop, to determine whether to generate the ricochet.

According to one or more aspects, the ricochet probability, also referred to as a ricochet rate, is a numerical value measuring a probability that the projectile is bounced off in a specific condition. This attribute affects whether the projectile ricochets when hitting the virtual item and how the projectile behaves after ricocheting.

In some arrangements, the ricochet probability is further affected by an attribute value of a first virtual role. For example, when an attack value caused by the first virtual role to a second virtual role within a threshold time is greater than or equal to a first attack value threshold, the ricochet probability is improved. For example, if an attack value received by the first virtual role from the second virtual role within the threshold time is greater than or equal to a second attack value threshold, the ricochet probability is reduced. In this approach, the ricochet probability is combined with an attribute value of a virtual role. When the first virtual role outputs a lot of attacks (for example, in a state of sustained attacks and hits), the ricochet probability is increased, and when the first virtual role is continuously attacked, the probability is reduced. This approach embodies a competitive mindset of “growing braver in a battle”, thereby helping improve game experience of users and enrich forms of human-computer interaction.

In one or more examples, a manner for determining the ricochet probability includes at least one operation of the following operations 431 to 434 (not shown in the figure).

Operation 431: Determine a base value of the ricochet probability based on a material of the virtual item, virtual items of different materials corresponding to different base values.

For example, the different base values of the ricochet probability are set in advance for the virtual items of different materials. The base value may be inversely correlated to roughness of the material of the virtual item. For example, based on the material of the virtual item, the base value increases as the material becomes smoother, and the base value decreases as the material becomes rougher. In some examples, the base value is a numerical value between 0 and 1.

According to one or more aspects, a correspondence table between the material of the virtual item and the base value of the ricochet probability is configured in advance. After the material of the virtual item is determined, the base value of the ricochet probability corresponding to the virtual item is determined from the correspondence table.

For example, a base value of a ricochet probability of metal>a base value of a ricochet probability of concrete>a base value of a ricochet probability of wood>a base value of a ricochet probability of dirt.

Operation 432: Determine a scaling factor of the ricochet probability based on the material of the virtual item and an incident angle at which the first projectile collides with the virtual item.

According to one or more arrangements, the scaling factor of the ricochet probability is configured in advance for different incident angles and materials of the virtual item. For example, for the different materials of the virtual item, the scaling factor of the incident angle and the ricochet probability satisfy different functional relationships. As shown in sub-figure (a) of FIG. 6, a functional relationship between the incident angle and a scaling factor of the ricochet probability of metal and concrete is shown. For example, a base value of the scaling factor of the ricochet probability of metal and concrete is 0.5, and the scaling factor of the ricochet probability of metal and concrete increases as the incident angle increases until the scaling factor increases to 1. As shown in sub-figure (b) of FIG. 6, a functional relationship between the incident angle and a scaling factor of the ricochet probability of wood and dirt is shown. For example, a base value of the scaling factor of the ricochet probability of wood and dirt is 0.25, and the scaling factor of the ricochet probability of wood and dirt increases as the incident angle increases until the scaling factor increases to 1.

According to one or more aspects, the material of the virtual item is first determined, and after the material of the virtual item is determined, the functional relationship between the incident angle and the scaling factor for the material is found. Further, the incident angle is obtained, and is substituted into the function relationship, to obtain the scaling factor.

For example, the scaling factor is a factor configured for scaling the ricochet probability. For example, the scaling factor is a numerical value greater than 0 and less than or equal to 1. Additionally or alternatively, a larger incident angle indicates a larger scaling factor.

Operation 433: Determine a bonus factor of the ricochet probability based on a type of the first projectile, different types of projectiles corresponding to different bonus factors.

In some arrangements, the bonus factor of the ricochet probability is determined based on a type of the virtual shooting prop to which the first projectile belongs. Different types of projectiles correspond to different bonus factors.

For example, different bonus factors of the ricochet probability are set in advance for different virtual shooting props. The bonus factor is a factor configured for boosting the ricochet probability. For example, the bonus factor is a numerical value between 0 and 1.

In one or more arrangements, a correspondence table between the virtual shooting prop and the bonus factor of the ricochet probability is configured in advance. After the category of the virtual shooting prop is determined, the bonus factor of the ricochet probability is determined from the correspondence table.

The following Table 2 shows an example correspondence among the category of the virtual shooting prop to which the first projectile belongs, the bonus factor, and a maximum quantity of ricochets.

TABLE 2
Correspondence between a category of a virtual shooting
prop to which a first projectile belongs, a bonus factor,
and a maximum quantity of ricochets

| | | Maximum |
|---|---|---|
| Category of a virtual shooting | Bonus factor | quantity of ricochets |
| prop | (ricochet bonus) | (Specified quantity) |
| First virtual shooting prop | 0.9 | 1 |
| Second virtual shooting prop | 0.5 | 1 |
| Third virtual shooting prop | 0.7 | 2 |
| Fourth virtual shooting prop | 0.7 | 2 |
| Fifth virtual shooting prop | 0.5 | 3 |
| Sixth virtual shooting prop | 0.2 | 1 |
| Seventh virtual shooting prop | 0.9 | 3 |

As shown in Table 2, for different categories of virtual shooting props, categories of projectiles released by the virtual shooting props are also different, bonus factors are also different, and maximum quantities of ricochets (or referred to as the specified quantity and a maximum quantity of bounces) are also different.

Operation 434: Determine the ricochet probability based on the base value of the ricochet probability, the scaling factor of the ricochet probability, and the bonus factor of the ricochet probability.

In one or more arrangements, a product of the base value of the ricochet probability, the scaling factor of the ricochet probability, and the bonus factor of the ricochet probability is determined as the ricochet probability. For example, the ricochet probability=the base value of the ricochet probability*the scaling factor of the ricochet probability*the bonus factor of the ricochet probability.

In other arrangements, a product of the base value of the ricochet probability and the scaling factor of the ricochet probability is determined as the ricochet probability. For example, the ricochet probability=the base value of the ricochet probability*the scaling factor of the ricochet probability.

In still other arrangements, a product of the base value of the ricochet probability and the bonus factor of the ricochet probability is determined as the ricochet probability. For example, the ricochet probability=the base value of the ricochet probability*the bonus factor of the ricochet probability.

Operation 440: Generate a random factor based on the ricochet probability.

According to one or more aspects, the random factor may be considered as different numerical values, such as at least one of a second numerical value, a third numerical value, or a fourth numerical value. In some arrangements, the second numerical value indicates that the first projectile generates the ricochet effect on the virtual item, so that the second numerical value serves as a generated random factor, and a generation probability of the second numerical value is equal to the ricochet probability. In other arrangements, a numerical value other than the second numerical value indicates that the first projectile does not generate the ricochet effect on the virtual item.

Operation 450: Display, when the random factor indicates that the first projectile generates the ricochet effect on the virtual item, the ricochet effect of the first projectile generated on the virtual item.

According to one or more aspects, when the random factor is the second numerical value, it is considered that the random factor indicates that the first projectile generates the ricochet effect on the virtual item, so that the ricochet effect of the first projectile generated on the virtual item is displayed.

Additionally or alternatively, if the random factor is a value other than the second numerical value, it is considered that the random factor does not indicate that the first projectile generates the ricochet effect on the virtual item, or indicates that the first projectile does not generate the ricochet effect on the virtual item, so that the ricochet effect of the first projectile generated on the virtual item is not displayed.

According to one or more aspects described herein, a level of the ricochet probability determines a level of a probability of generating the ricochet effect. Based on this, the ricochet effect shown in this application conforms to probability distribution, thereby helping improve accuracy of ricocheting. Further, the level of the ricochet probability is affected by the base value of the ricochet probability, the scaling factor of the ricochet probability, and the bonus factor of the ricochet probability. The base value of the ricochet probability is related to the material of the virtual item, the scaling factor of the ricochet probability is related to the incident angle and the material of the virtual item, and the bonus factor of the ricochet probability is related to the type of the projectile. In one or more arrangements, the ricochet probability is determined by a plurality of factors combined. A finally determined ricochet probability may be a ricochet probability that best fits a game situation and is reasonable.

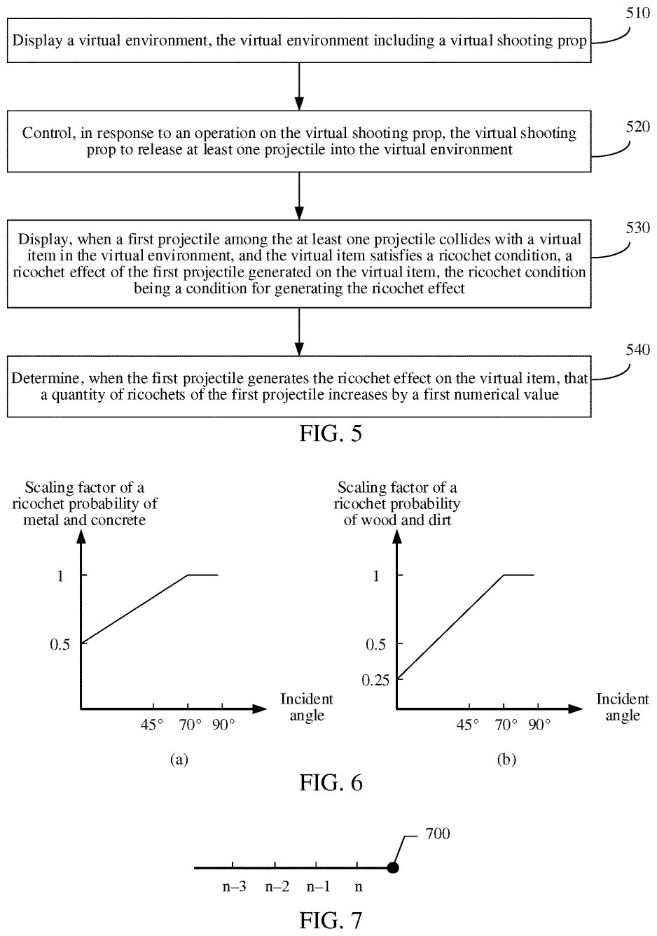

Referring to FIG. 5, FIG. 5 is a flowchart of another example interface display method according to one or more aspects described herein. The method may be executed by the terminal device 10 introduced above. For example, operations are executed by the client of the target application program described herein. In the following description, only an example in which the operations are executed by a “client” is used. The method may include at least one of the following operations (510 to 540):

Operation 510: Display a virtual environment, the virtual environment including a virtual shooting prop.

Operation 520: Control, in response to an operation on the virtual shooting prop, the virtual shooting prop to release at least one projectile into the virtual environment.

Operation 530: Display, when a first projectile among the at least one projectile collides with a virtual item in the virtual environment, and the virtual item satisfies a ricochet condition, a ricochet effect of the first projectile generated on the virtual item, the ricochet condition being a condition for generating the ricochet effect.

Operation 540: Determine, when the first projectile generates the ricochet effect on the virtual item, that a quantity of ricochets of the first projectile increases by a first numerical value.

In some arrangements, the first numerical value is fixed. For example, the first numerical value is 1. To be specific, each time the first projectile ricochets, the quantity of ricochets increases by 1.

Additionally or alternatively, the quantity of ricochets of the first projectile is less than or equal to a specified quantity, and the first projectile that generates the ricochet effect on the virtual item is allowed to collide again with another virtual item in the virtual environment.

In some examples, when the quantity of ricochets of the first projectile is equal to the specified quantity, it is considered that the first projectile no longer generates the ricochet effect. In one or more arrangements, when the quantity of ricochets of the first projectile is less than or equal to the specified quantity, the first projectile that generates the ricochet effect on the virtual item is allowed to collide again with another virtual item in the virtual environment.

According to one or more aspects, if the first projectile that has generated the ricochet effect on the virtual item collides again with another virtual item in the virtual environment, operation 530 is performed again. After a ricochet is triggered for the first time, a ricochet probability of the projectile is recalculated based on a material of the another virtual item shot by the projectile. If a non-bouncy material is shot at this time, a ricochet mechanism is stopped. If bouncy materials are shot consecutively, and ricochets are triggered, the projectile stops triggering the ricochet mechanism after a maximum quantity of ricochets is achieved.

In some arrangements, the first numerical value is not fixed. For example, the first numerical value is related to the material of the virtual item. Accordingly, a level of the first numerical value needs to be determined based on the material of the virtual item. In one or more examples, different first numerical values are set for materials of different virtual items in advance. For virtual items of different materials, consumption caused by ricocheting the first projectile needs to be different. Therefore, the first numerical value is dynamically changed based on the material of the virtual item. For example, a first numerical value corresponding to a virtual item of a smooth material is less than a first numerical value corresponding to a virtual item of a rough material. In one example, the first projectile can ricochet on the virtual item of the smooth material up to 6 times, but can ricochet on the virtual item of the rough material only 3 times. For example, ricocheting on the virtual item of the rough material once is equal to ricocheting on the virtual item of the smooth material twice.

According to one or more aspects described herein, the first numerical value is dynamically adjusted, so that flexibility and diversity of a ricochet manner are improved, thereby helping improve efficiency of human-computer interaction.

The following describes that the specified quantity may change.

In some arrangements, the virtual environment further includes a first virtual role holding the virtual shooting prop, and a second virtual role in a different camp from the first virtual role.

In some examples, the specified quantity is increased when the first virtual role and the second virtual role satisfy a specified condition.

For example, the specified quantity (a maximum quantity of bounces and a maximum quantity of ricochets) in this application may be fixed, or may dynamically change with different game situations.

According to one or more aspects, the specified condition includes at least one of the following: a distance between the first virtual role and the second virtual role is less than or equal to a first threshold; a quantity of second virtual roles in a range with the first virtual role as a circle center and a first specified distance as a radius is greater than or equal to a second threshold; or a difference between an attribute value of the first virtual role and an attribute value of the second virtual role is greater than or equal to a third threshold. The first threshold, the second threshold, and the third threshold are respectively set according to actual technical requirements.

For example, this application provides several conditions in which the specified quantity may be increased.

In one example, when the distance between the first virtual role and the second virtual role is less than or equal to the first threshold, the specified quantity is increased. For example, the increased specified quantity is in negative correlation with the distance between the first virtual role and the second virtual role. In other words, a smaller distance between the first virtual role and the second virtual role indicates a larger numerical value of the increased specified quantity. In this case, the second virtual role is close to the first virtual role (an enemy character is close). In this case, to protect the first virtual role, the specified quantity is increased, to improve a hit rate against the second virtual role.

Additionally or alternatively, when the quantity of second virtual roles in the range with the first virtual role as the center and the first specified distance as the radius is greater than or equal to the second threshold, the specified quantity is increased. For example, the increased specified quantity is in positive correlation with the quantity of second virtual roles. In other words, a larger quantity of second virtual roles near the first virtual role indicates a larger numerical value of the increased specified quantity. In this case, there are many second virtual roles (there are many enemy characters) near the first virtual role. To protect the first virtual role, the specified quantity is increased, to improve a hit rate against at least one second virtual role.

In some arrangements, when the difference between the attribute value of the first virtual role and the attribute value of the second virtual role is greater than or equal to the third threshold, the specified quantity is increased. For example, the increased specified quantity is in positive correlation with the difference. In other words, a larger difference indicates a larger value of the increased specified quantity. In this case, a gap between the first virtual role and the second virtual role is large (for example, the first virtual role is at a disadvantage and the second virtual role is at an advantage). To protect the first virtual role and improve user experience, the specified quantity is increased, to improve a hit rate against at least one second virtual role, thereby avoiding a one-sided situation in a game as much as possible. It is user-friendly for both new and experienced players, helping experienced players improve skills while enhancing the game experience for new players.

The following describes setting a ricochet point and placing the virtual item.

According to one or more aspects, a specified ricochet point is displayed based on the first virtual role and the second virtual role, the specified ricochet point being a point at which a second projectile among the at least one projectile hits the second virtual role after the second projectile generates a ricochet effect at the specified ricochet point.

In one or more arrangements, a position of the specified ricochet point is determined based on real-time positions of the first virtual role and the second virtual role. For example, the position of the specified ricochet point is determined based on real-time positions and running trends of the first virtual role and the second virtual role. For example, when the first virtual role controls the virtual shooting prop to release the projectile toward the specified ricochet point, if a ricochet occurs at the specified ricochet point, the second virtual role that is running is hit.

For example, a terminal device or a server may provide a plurality of specified ricochet points based on the real-time positions of the first virtual role and the second virtual role. For example, the plurality of specified ricochet points are highlighted in the virtual environment.

Considering that there may be or may not be a virtual item satisfying the ricochet condition at the specified ricochet point, the following processing is separately performed for the two situations.

In some arrangements, when there is the virtual item satisfying the ricochet condition at the specified ricochet point, the virtual shooting prop is controlled, in response to the operation on the virtual shooting prop, to release at least one projectile toward the specified ricochet point in the virtual environment.

For example, when there is the virtual item satisfying the ricochet condition at the specified ricochet point, the second virtual role can be hit by directly controlling the virtual shooting prop to release the at least one projectile toward the specified ricochet point in the virtual environment.

Alternatively or additionally, when there is no virtual item satisfying the ricochet condition at the specified ricochet point, a placement picture of placing the virtual item satisfying the ricochet condition at the specified ricochet point is displayed; and in response to the operation on the virtual shooting prop, the virtual shooting prop is controlled to release the at least one projectile toward the specified ricochet point in the virtual environment.

For example, when there is no virtual item satisfying the ricochet condition at the specified ricochet point, if there is a virtual item at the point originally, but the virtual item does not satisfy the ricochet condition, the original virtual item is replaced with the virtual item satisfying the ricochet condition. Alternatively or additionally, when there is no virtual item satisfying the ricochet condition at the specified ricochet point, if there is no virtual item at the point originally, the virtual item satisfying the ricochet condition is directly placed.

For example, a replacement picture of replacing the virtual item not satisfying the ricochet condition with the virtual item satisfying the ricochet condition at the specified ricochet point is displayed, and in response to the operation on the virtual shooting prop, the virtual shooting prop is controlled to release the at least one projectile toward the specified ricochet point in the virtual environment.

For example, the placement picture of placing the virtual item satisfying the ricochet condition at the specified ricochet point is displayed, and the virtual shooting prop is controlled, in response to the operation on the virtual shooting prop, to release at least one projectile toward the specified ricochet point in the virtual environment.

According to one or more aspects described herein, the specified ricochet point is provided, to reduce operating difficulty, thereby helping improve shooting experience of a user and enriching forms of human-computer interaction.

The following describes displaying probability prompt information.

According to one or more aspects, the probability prompt information is displayed, the probability prompt information being configured for prompting a hit probability corresponding to a shooting angle, the shooting angle being an angle at which the virtual shooting prop is controlled to release the at least one projectile into the virtual environment, and the hit probability corresponding to the shooting angle being a probability that the at least one projectile released at the shooting angle hits the second virtual role after the at least one projectile generates the ricochet effect or when the at least one projectile does not generate the ricochet effect.

In one example, before the virtual shooting prop is controlled to release the projectile, the probability prompt information is displayed in an aiming process.

According to one or more aspects, the hit probability is calculated based on the shooting angle, and the real-time positions of the first virtual role and the second virtual role by the terminal device or the server.

As noted above, the hit probability corresponding to the shooting angle is a probability that the at least one projectile released at the shooting angle hits the second virtual role after the at least one projectile generates the ricochet effect. For example, the hit probability corresponding to the shooting angle is a probability that the at least one projectile released at the shooting angle hits the second virtual role after the at least one projectile generates one ricochet effect. Additionally or alternatively, the hit probability corresponding to the shooting angle is a probability the at least one projectile released at the shooting angle hits the second virtual role after the at least one projectile generates a plurality of ricochet effects. In some examples, the hit probability corresponding to the shooting angle is a probability that the at least one projectile released at the shooting angle directly hits the second virtual role when the at least one projectile does not generate the ricochet effect.

According to one or more aspects described herein, the probability prompt information is displayed to indicate the user to calibrate the shooting angle, thereby improving the hit rate against the second virtual role.

The following describes displaying ricochet prompt information.

In some arrangements, the ricochet prompt information is displayed when the first projectile generates the ricochet effect on the virtual item, the ricochet prompt information being configured for indicating that the first projectile generates the ricochet effect.

For example, when the first projectile generates the ricochet effect on the virtual item, the ricochet prompt information is displayed. According to one or more aspects, the ricochet prompt information is configured for indicating that the first projectile generates the ricochet effect. For example, the ricochet prompt information is at least one of a text prompt, a picture prompt, or an animation prompt.

In one or more arrangements, when the first projectile generates the ricochet effect on the virtual item, an explosion animation is displayed at a collision point, the explosion animation being an animation prompt. For example, when the first projectile generates the ricochet effect on the virtual item, text “ricocheting ~” is displayed, the text “ricocheting ~” being a text prompt. In one or more examples, the text prompt may scroll across a screen like a bullet comment.

According to one or more aspects described herein, the ricochet prompt information is displayed, thereby improving a user's perception of the ricochet. Further, it is beneficial to adjusting the shooting angle in time, to implement hitting against the second virtual role.

The following describes triggering a ricochet sound effect.

According to some aspects, the ricochet sound effect is triggered or not triggered based on a shooting mode of the virtual shooting prop and a ricochet status of the at least one projectile, the shooting mode of the virtual shooting prop being determined by the operation on the virtual shooting prop, and the ricochet status including generating the ricochet effect or not generating the ricochet effect.

In some examples, different ricochet sound effects may be set for at least one of virtual items of different materials, projectiles of different types, or virtual shooting props of different types. For example, different ricochet sound effects include, but are not limited to, different tones and timbres.

Additionally or alternatively, in response to the operation on the virtual shooting prop, the virtual shooting prop is controlled to enter different shooting modes. When operation types of the operation on the virtual shooting prop are different, shooting modes that the virtual prop is controlled to enter are different. An operation type includes, but is not limited to, at least one of a click/tap operation, a long-press operation, a double-click/tap operation, a gesture operation, or a slide operation.

For example, when the projectile generates the ricochet effect, the ricochet sound effect is triggered. Additionally or alternatively, when the projectile does not generate the ricochet effect, the ricochet sound effect is not triggered.

In some arrangements, when it is determined based on the operation on the virtual shooting prop that the virtual shooting prop is in the first shooting mode, the ricochet sound effect is randomly triggered if a projectile other than the last projectile among the at least one projectile generates the ricochet effect.

For example, the first shooting mode is also referred to as an automatic firing mode. In this mode, when a projectile before the last projectile ricochets, the ricochet sound effect is randomly triggered based on a preset probability. In other words, the ricochet sound effect is not triggered each time the ricochet occurs, to reduce a possibility of triggering the ricochet sound effect, thereby avoiding that the user is affected by a redundant sound effect and loses a real perception of the game.

According to one or more aspects, when the operation on the virtual shooting prop is a long-press operation on a shooting control, it is determined that the virtual shooting prop is in the first shooting mode.

For example, the shooting control may also be referred to as a firing control. In some arrangements, when the operation on the virtual shooting prop is the long-press operation on the shooting control, it is determined that the virtual shooting prop is in the first shooting mode. In other words, in response to the long-press operation on the firing control, it is determined that the virtual shooting prop is in the first shooting mode. In one or more examples, an operation interval of the long-press operation is longer than an interval (e.g., required amount of time) of releasing the projectile by the virtual shooting prop.

For example, in response to another (e.g., a further) trigger operation on the shooting or firing control, it is considered that the first shooting mode is exited.

In the example shown in FIG. 7, n represents a quantity of projectiles, and n is an integer. In one or more arrangements, when the last projectile 700 generates a ricochet effect, the ricochet sound effect is triggered when the another trigger operation is stopped.

In some arrangements, when it is determined based on the operation on the virtual shooting prop that the virtual shooting prop is in the second shooting mode, the ricochet sound effect is not triggered if a projectile other than the last projectile among the at least one projectile generates the ricochet effect.

According to one or more aspects, when the virtual shooting prop is in the first shooting mode or the second shooting mode, the ricochet sound effect is triggered if the last projectile among the at least one projectile generates the ricochet effect; or the ricochet sound effect is not triggered if the last projectile among the at least one projectile does not generate the ricochet effect. In one example, the first shooting mode is the automatic firing mode, and the second shooting mode is a continuous firing mode.

In some arrangements, when the operation on the virtual shooting prop is a continuous press operation on the shooting control, it is determined that the virtual shooting prop is in the second shooting mode. For example, the continuous press operation may also be understood as or correspond to a plurality of press operations.

In one example, the second shooting mode is also referred to as the continuous firing mode. In this mode, when the projectile before the last projectile ricochets, the ricochet sound effect is not triggered. In other words, no ricochet sound effect is triggered each time the ricochet occurs, to reduce the possibility of triggering the ricochet sound effect, thereby avoiding that the user is affected by the redundant sound effect and loses the real perception of the game.

As discussed, the shooting control may also be referred to as the firing control. In some arrangements, when the operation on the virtual shooting prop is a continuous press operation on the firing control, it is determined that the virtual shooting prop is in the second shooting mode. In other words, in response to the continuous press operation on the firing control, it is determined that the virtual shooting prop is in the second shooting mode.

As shown in the example of FIG. 7, n represents the quantity of projectiles, and n is an integer. In some arrangements, when the last projectile 700 generates the ricochet effect, and the last outputted object is released corresponding to the last trigger operation in the continuous press operation on the firing control, the ricochet sound effect is triggered when the last trigger operation is stopped.

In one or more examples, regardless of which shooting mode the virtual shooting prop is in, output or ricochet of the last projectile among the at least one projectile indicates that a shooting period ends. In this case, triggering the ricochet sound effect does not affect the user's perception of the game.

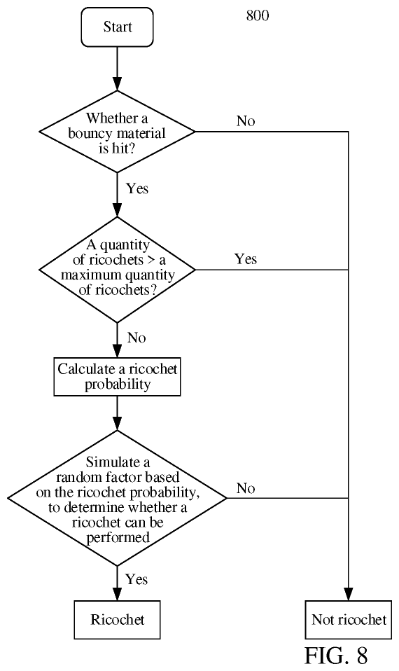

FIG. 8 illustrates a block diagram 900 of an example decision method for generating a ricochet effect according to one or more aspects described herein. First, the material of the virtual item needs to be determined. When the material of the virtual item is a bouncy material, it needs to be determined whether a current quantity of ricochets is greater than the maximum quantity of ricochets. If yes, no ricochet is performed. When the material is a non-bouncy material, no ricochet is performed. Further, when the quantity of ricochets is not greater than the maximum quantity of ricochets, the random factor is simulated based on a ricochet probability, to determine whether the ricochet can be performed. If it is indicated that the ricochet can be performed, the ricochet is performed; otherwise, the ricochet is not performed. Bounce and ricochet as described herein may be considered as having the same meaning, and are not further distinguished according to some aspects described herein.

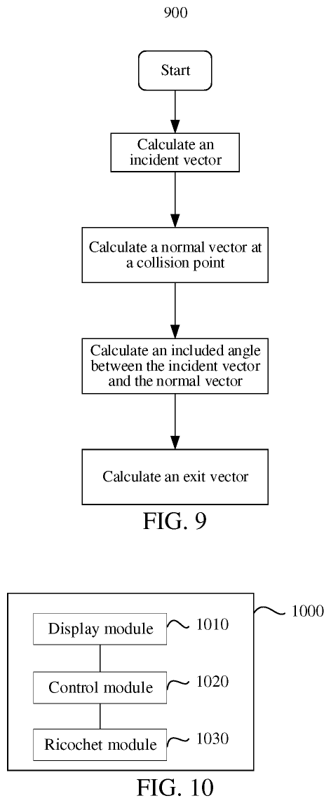

FIG. 9 illustrates a block diagram 900 of an example determination method for a reflection angle according to one or more aspects described herein. An included angle between a current incident vector and a normal vector of a surface of a collision point is calculated, and is considered as an incident angle. A reflection operation is performed on the incident angle to determine an exit angle. In this case, the exit angle needs to be the same as the incident angle, to determine an exit vector.

According to one or more aspects described herein, considering that the ricochet sound effect is a prompt sound, if the sound is triggered each time of firing, audio-visual feedback of a player is easily interfered with (e.g., the player may be easily distracted or confused). Therefore, a probability that the player hears the ricochet sound effect needs to be reduced as much as possible. For example, similar to the virtual shooting prop in the second shooting mode (the continuous firing mode), because of a high shooting rate, when a quantity of projectiles fired each time is small, a quantity of times of playing the ricochet sound effect is reduced as much as possible, to decouple from a logic of playing the ricochet sound effect of the virtual shooting prop in the first shooting mode (the automatic firing mode).

According to aspects described herein, a new design of a ricochet mechanism and experience thereof in a virtual computer environment are provided. According to one or more aspects, the ricochet mechanism can be triggered when different projectiles hit different bouncy materials, and the player can experience a more realistic battlefield atmosphere by means of corresponding special effects and sound effects, and deeply feel tension of battle and realism of operation. An unpredictable ricochet mechanism can influence battle experience to some extent, and provide players with an extra sense of novelty and excitement. In addition, an elaborate sound effect design can effectively render an ambient environment, and deepen the interpretation of the game's realistic style.

The following describes example apparatuses that can be configured for executing the various processes and functions described herein.

FIG. 10 is a block diagram of an example interface display apparatus according to one or more aspects described herein. The apparatus has a function of performing one or more aspects of the processes and methods described herein, and the function may be implemented by hardware or may be implemented by hardware executing corresponding software. The apparatus may be the terminal device introduced above, or may be disposed in a terminal device. As shown in FIG. 10, the apparatus 1000 may include a display module 1010, a control module 1020, and a ricochet module 1030.

The display module 1010 is configured to display a virtual environment, the virtual environment including a virtual shooting prop.

The control module 1020 is configured to control, in response to an operation on the virtual shooting prop, the virtual shooting prop to release at least one projectile into the virtual environment.

The ricochet module 1030 is configured to display, when a first projectile among the at least one projectile collides with a virtual item in the virtual environment, and the virtual item satisfies a ricochet condition, a ricochet effect of the first projectile generated on the virtual item, the ricochet condition being a condition for generating the ricochet effect.

In some examples, the ricochet condition includes at least one of the following: a material of the virtual item belongs to a material of a specified category; a quantity of ricochets of the first projectile is less than a specified quantity; the virtual environment belongs to a virtual environment of a specified category; or the virtual shooting prop belongs to a virtual shooting prop of a specified category.

In some arrangements, the ricochet module 1030 is further configured to: determine a ricochet probability based on the first projectile and the virtual item, the ricochet probability being configured for characterizing a probability that the first projectile generates the ricochet effect on the virtual item; generate a random factor based on the ricochet probability; and perform, when the random factor indicates that the first projectile generates the ricochet effect on the virtual item, an operation of displaying the ricochet effect of the first projectile generated on the virtual item.

In further arrangements, the ricochet module 1030 is further configured to: determine a base value of the ricochet probability based on the material of the virtual item, virtual items of different materials corresponding to different base values; determine a scaling factor of the ricochet probability based on the material of the virtual item and an incident angle at which the first projectile collides with the virtual item; determine a bonus factor of the ricochet probability based on a type of the first projectile, different types of projectiles corresponding to different bonus factors; and determine the ricochet probability based on the base value of the ricochet probability, the scaling factor of the ricochet probability, and the bonus factor of the ricochet probability.

According to other aspects, the ricochet module 1030 is further configured to determine, when the first projectile generates the ricochet effect on the virtual item, that the quantity of ricochets of the first projectile increases by a first numerical value, the quantity of ricochets of the first projectile being less than or equal to the specified quantity, and the first projectile that generates the ricochet effect on the virtual item being allowed to collide again with another virtual item in the virtual environment.

According to still other aspects, the virtual environment further includes a first virtual role holding the virtual shooting prop, and a second virtual role in a different camp from the first virtual role.

In some examples, the ricochet module 1030 is further configured to increase the specified quantity when the first virtual role and the second virtual role satisfy a specified condition, the specified condition including at least one of the following: a distance between the first virtual role and the second virtual role is less than or equal to a first threshold; a quantity of second virtual roles in a range with the first virtual role as a circle center and a first specified distance as a radius is greater than or equal to a second threshold; or a difference between an attribute value of the first virtual role and an attribute value of the second virtual role is greater than or equal to a third threshold.

Additionally or alternatively, the ricochet module 1030 is further configured to: display a specified ricochet point based on the first virtual role and the second virtual role, the specified ricochet point being a point at which a second projectile among the at least one projectile hits the second virtual role after the second projectile generates a ricochet effect at the specified ricochet point; and when there is a virtual item satisfying the ricochet condition at the specified ricochet point, control, in response to the operation on the virtual shooting prop, the virtual shooting prop to release at least one projectile toward the specified ricochet point in the virtual environment; or display, when there is no virtual item satisfying the ricochet condition at the specified ricochet point, a placement picture of placing the virtual item satisfying the ricochet condition at the specified ricochet point; and control, in response to the operation on the virtual shooting prop, the virtual shooting prop to release the at least one projectile toward the specified ricochet point in the virtual environment.

In some arrangements, the display module 1010 is further configured to display probability prompt information, the probability prompt information being configured for prompting a hit probability corresponding to a shooting angle, the shooting angle being an angle at which the virtual shooting prop is controlled to release the at least one projectile into the virtual environment, and the hit probability corresponding to the shooting angle being a probability that the at least one projectile released at the shooting angle hits the second virtual role after the at least one projectile generates the ricochet effect or when the at least one projectile does not generate the ricochet effect.

According to one or more aspects, the display module 1010 is further configured to display ricochet prompt information when the first projectile generates the ricochet effect on the virtual item, the ricochet prompt information being configured for indicating that the first projectile generates the ricochet effect.

In some examples, the ricochet module 1030 is further configured to trigger or skipping triggering a ricochet sound effect based on a shooting mode of the virtual shooting prop and a ricochet status of the at least one projectile, the shooting mode of the virtual shooting prop being determined by the operation on the virtual shooting prop, and the ricochet status including generating the ricochet effect or not generating the ricochet effect.

In some arrangements, the ricochet module 1030 is further configured to: when it is determined based on the operation on the virtual shooting prop that the virtual shooting prop is in a first shooting mode, randomly trigger the ricochet sound effect if a projectile other than the last projectile among the at least one projectile generates the ricochet effect; when it is determined based on the operation on the virtual shooting prop that the virtual shooting prop is in a second shooting mode, skip triggering the ricochet sound effect if a projectile other than the last projectile among the at least one projectile generates the ricochet effect; and when the virtual shooting prop is in the first shooting mode or the second shooting mode, trigger the ricochet sound effect if the last projectile among the at least one projectile generates the ricochet effect; or skip triggering the ricochet sound effect if the last projectile among the at least one projectile does not generate the ricochet effect.

In some aspects, the control module 1020 is further configured to: determine, when the operation on the virtual shooting prop is a long-press operation on a shooting control, that the virtual shooting prop is in the first shooting mode; and determine, when the operation on the virtual shooting prop is a continuous press operation on the shooting control, that the virtual shooting prop is in the second shooting mode.

When the apparatus implements the functions of the apparatus, division of the foregoing function modules is merely an example for description of how the functions may be allocated and/or performed. In other arrangements or scenarios, the functions may be allocated to and completed by different functional modules according to requirements. That is, a content structure of the device is divided into different function modules, to complete all or some of the functions described above. Details of example implementation processes are described above, and are not repeated here.

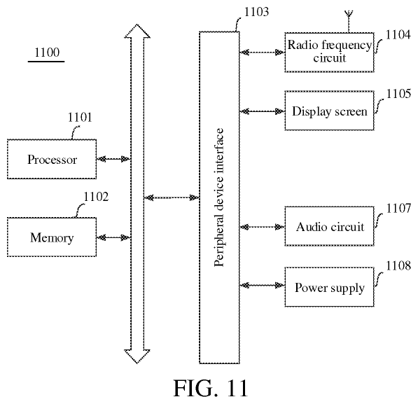

FIG. 11 is a structural block diagram of an example terminal device 1100 according to one or more aspects described herein. The terminal device 1100 may be the terminal device 10 in the environment shown in FIG. 1, and is configured to implement the interface display methods and processes described herein. Specifically as follows:

Generally, the terminal device 1100 includes a processor 1101 and a memory 1102.

The processor 1101 may include one or more processing cores, for example, a 4-core processor or an 8-core processor. The processor 1101 may be implemented in at least one hardware form of a digital signal processor (DSP), a field programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process data in a standby state. In some examples, the processor 1101 may be integrated with a graphics processing unit (GPU), and the GPU is configured to be responsible for rendering and drawing content that needs to be displayed on a display screen. In some examples, the processor 1101 may further include an artificial intelligence (AI) processor. The AI processor is configured to process a calculation operation related to machine learning.

The memory 1102 may include one or more computer-readable storage media, and the computer-readable storage media may be non-transitory. The memory 1102 may include a high-speed random access memory and a nonvolatile memory, for example, one or more magnetic disk storage devices and flash memory devices. In some arrangements, the non-transitory computer-readable storage medium in the memory 1102 is configured to store a computer program, and the computer program is configured to be executed by one or more processors, to implement the foregoing interface display method.

In some arrangements, the terminal device 1100 may further include a peripheral device interface 1103 and at least one peripheral device. The processor 1101, the memory 1102, and the peripheral device interface 1103 may be connected to each other through a bus or a signal line. Each peripheral device may be connected to the peripheral device interface 1103 through a bus, a signal line, or a circuit board. Specifically, the peripheral device includes at least one of a radio frequency circuit 1104, a display screen 1105, an audio circuit 1107, or a power supply 1108.

A person skilled in the art may understand that the structure shown in FIG. 11 constitutes no limitation on the terminal device 1100, and the terminal device may include more or fewer components than those shown in the figure, or some components may be combined, or a different component deployment may be used.

In one or more arrangements, a computer-readable storage medium is provided, the computer-readable storage medium having a computer program stored therein, and the computer program being executed by a processor to implement the foregoing interface display method. In one example, the computer-readable storage medium may include: a read-only memory (ROM), a random access memory (RAM), a solid state drives (SSD), an optical disc, or the like. The RAM may include a resistance random access memory (ReRAM) and a dynamic random access memory (DRAM).

According to one or more aspects, a computer program product is provided, the computer program product including a computer program, and the computer program being stored in a computer-readable storage medium. A processor of a terminal device reads the computer program from the computer-readable storage medium, and the processor executes the computer program, so that the terminal device executes the foregoing interface display method.

During example implementation, collection and processing of related data (including a virtual shooting prop, a virtual item, and the like) in this application need to obtain informed consent or independent consent of a personal information subject strictly according to requirements of laws and regulations of related nations, and perform subsequent data use and processing behaviors within the laws and regulations and the authorization scope of the personal information subject.

“Plurality of” mentioned in this specification means two or more. “And/or” describes an association relationship for describing associated objects and represents that three relationships may exist. For example, A and/or B may represent the following three cases: Only A exists, both A and B exist, and only B exists. The character “/” generally represents an “or” relationship between the associated objects. In addition, the operation numbers described in this specification merely exemplarily show a possible execution sequence of the operations. In some other examples, the operations may not be performed according to the number sequence. For example, two operations with different numbers may be performed simultaneously, or two operations with different numbers may be performed according to a sequence contrary to the sequence shown in the figure. Aspects described herein are not limited to such examples.

The foregoing descriptions are merely exemplary, and are not intended to limit this application. Any modification, equivalent replacement, or improvement made within the spirit and principle of this application shall fall within the protection scope of this application.

What is claimed is:

1. An interface generation and display method, the method being performed by a terminal device and the method comprising:
displaying a computer-generated virtual environment, the virtual environment comprising a virtual shooting prop;
detecting an operation on the virtual shooting prop;
controlling, in response to detecting the operation on the virtual shooting prop, the virtual shooting prop to release at least one projectile into the virtual environment, the at least one projectile including a first projectile;
determining whether the first projectile collides with a virtual item in the virtual environment;
determining whether the virtual item satisfies a ricochet condition; and
generating and displaying, in response to determining that the first projectile among the at least one projectile collides with the virtual item in the virtual environment, and the virtual item satisfies the ricochet condition, a ricochet effect of the first projectile generated on the virtual item, the ricochet condition being a condition required for generating the ricochet effect.

2. The method according to claim 1, wherein the ricochet condition comprises at least one of the following:
a material of the virtual item belongs to a material of a specified category;
a quantity of ricochets of the first projectile is less than a specified quantity;
the virtual environment belongs to a virtual environment of a specified category; or
the virtual shooting prop belongs to a virtual shooting prop of a specified category.

3. The method according to claim 1, wherein the method further comprises:
determining a ricochet probability based on the first projectile and the virtual item, the ricochet probability being configured for characterizing a probability that the first projectile generates the ricochet effect on the virtual item;
generating a random factor based on the ricochet probability; and
performing, when the random factor indicates that the first projectile generates the ricochet effect on the virtual item, the step of generating and displaying a ricochet effect of the first projectile generated on the virtual item.

4. The method according to claim 3, wherein the determining a ricochet probability based on the first projectile and the virtual item comprises:
determining a base value of the ricochet probability based on a material of the virtual item, virtual items of different materials corresponding to different base values;
determining a scaling factor of the ricochet probability based on the material of the virtual item and an incident angle at which the first projectile collides with the virtual item;
determining a bonus factor of the ricochet probability based on a type of the first projectile, different types of projectiles corresponding to different bonus factors; and
determining the ricochet probability based on the base value of the ricochet probability, the scaling factor of the ricochet probability, and the bonus factor of the ricochet probability.

5. The method according to claim 1, wherein the method further comprises:
determining, when the first projectile generates the ricochet effect on the virtual item, that a quantity of ricochets of the first projectile increases by a first numerical value,
the quantity of ricochets of the first projectile being less than or equal to a specified quantity, and the first projectile that generates the ricochet effect on the virtual item being allowed to collide again with another virtual item in the virtual environment.

6. The method according to claim 5, wherein the virtual environment further comprises a first virtual role holding the virtual shooting prop, and a second virtual role in a different camp from the first virtual role, and the method further comprises:
increasing the specified quantity when the first virtual role and the second virtual role satisfy a specified condition,
the specified condition comprising at least one of the following: a distance between the first virtual role and the second virtual role is less than or equal to a first threshold; a quantity of second virtual roles in a range with the first virtual role as a circle center and a first specified distance as a radius is greater than or equal to a second threshold; or a difference between an attribute value of the first virtual role and an attribute value of the second virtual role is greater than or equal to a third threshold.

7. The method according to claim 6, wherein the method further comprises:
determining and displaying a specified ricochet point based on the first virtual role and the second virtual role, the specified ricochet point being a point at which a second projectile among the at least one projectile hits the second virtual role after the second projectile generates a ricochet effect at a point at the specified ricochet point; and
when there is a virtual item satisfying the ricochet condition at the specified ricochet point, controlling, in response to the operation on the virtual shooting prop, the virtual shooting prop to release at least one projectile toward the specified ricochet point in the virtual environment; or
displaying, when there is no virtual item satisfying the ricochet condition at the specified ricochet point, a placement picture of placing a virtual item satisfying the ricochet condition at the specified ricochet point; and controlling, in response to the operation on the virtual shooting prop, the virtual shooting prop to release at least one projectile toward the specified ricochet point in the virtual environment.

8. The method according to claim 6, wherein the method further comprises:
displaying probability prompt information, the probability prompt information being configured for prompting a hit probability corresponding to a shooting angle, the shooting angle being an angle at which the virtual shooting prop is controlled to release the at least one projectile into the virtual environment, and the hit probability corresponding to the shooting angle being a probability that the at least one projectile released at the shooting angle hits the second virtual role after the at least one projectile generates the ricochet effect or when the at least one projectile does not generate the ricochet effect.

9. The method according to claim 1, wherein the method further comprises:
displaying ricochet prompt information when the first projectile generates the ricochet effect on the virtual item, the ricochet prompt information being configured for indicating that the first projectile generates the ricochet effect.

10. The method according to claim 1, wherein the method further comprises:
triggering or skipping triggering a ricochet sound effect based on a shooting mode of the virtual shooting prop and a ricochet status of the at least one projectile, the shooting mode of the virtual shooting prop being determined by the operation on the virtual shooting prop, and the ricochet status comprising generating the ricochet effect or not generating the ricochet effect.

11. The method according to claim 10, wherein the triggering or skipping triggering a ricochet sound effect based on a shooting mode of the virtual shooting prop and a ricochet status of the at least one projectile comprises:
when it is determined based on the operation on the virtual shooting prop that the virtual shooting prop is in a first shooting mode, randomly triggering the ricochet sound effect if a projectile other than a last projectile among the at least one projectile generates the ricochet effect;
when it is determined based on the operation on the virtual shooting prop that the virtual shooting prop is in a second shooting mode, skipping triggering the ricochet sound effect if a projectile other than the last projectile among the at least one projectile generates the ricochet effect; and
when the virtual shooting prop is in the first shooting mode or the second shooting mode, triggering the ricochet sound effect if the last projectile among the at least one projectile generates the ricochet effect; or skipping triggering the ricochet sound effect if the last projectile among the at least one projectile does not generate the ricochet effect.

12. The method according to claim 11, wherein the method further comprises:
determining, when the operation on the virtual shooting prop is a long-press operation on a shooting control, that the virtual shooting prop is in the first shooting mode; or
determining, when the operation on the virtual shooting prop is a continuous press operation on a shooting control, that the virtual shooting prop is in the second shooting mode.

13. An apparatus comprising:
a processor; and
memory storing computer-readable instructions that, when executed, cause the apparatus to:
display a computer-generated virtual environment, the virtual environment comprising a virtual shooting prop;
detect an operation on the virtual shooting prop;
control, in response to detecting the operation on the virtual shooting prop, the virtual shooting prop to release at least one projectile into the virtual environment, the at least one projectile including a first projectile;
determine whether the first projectile collides with a virtual item in the virtual environment;
determine whether the virtual item satisfies a ricochet condition; and
generate and display, in response to determining that the first projectile among the at least one projectile collides with the virtual item in the virtual environment, and the virtual item satisfies the ricochet condition, a ricochet effect of the first projectile generated on the virtual item, the ricochet condition being a condition required for generating the ricochet effect.

14. The apparatus according to claim 13, wherein the ricochet condition comprises at least one of the following:
a material of the virtual item belongs to a material of a specified category;
a quantity of ricochets of the first projectile is less than a specified quantity;
the virtual environment belongs to a virtual environment of a specified category; or
the virtual shooting prop belongs to a virtual shooting prop of a specified category.

15. The apparatus according to claim 13, wherein the instructions, when executed, further cause the apparatus to:
determine a ricochet probability based on the first projectile and the virtual item, the ricochet probability being configured for characterizing a probability that the first projectile generates the ricochet effect on the virtual item;
generate a random factor based on the ricochet probability; and
perform, when the random factor indicates that the first projectile generates the ricochet effect on the virtual item, the step of generating and displaying a ricochet effect of the first projectile generated on the virtual item.

16. The apparatus according to claim 15, wherein the determining a ricochet probability based on the first projectile and the virtual item comprises:
determining a base value of the ricochet probability based on a material of the virtual item, virtual items of different materials corresponding to different base values;
determining a scaling factor of the ricochet probability based on the material of the virtual item and an incident angle at which the first projectile collides with the virtual item;
determining a bonus factor of the ricochet probability based on a type of the first projectile, different types of projectiles corresponding to different bonus factors; and
determining the ricochet probability based on the base value of the ricochet probability, the scaling factor of the ricochet probability, and the bonus factor of the ricochet probability.

17. The apparatus according to claim 13, wherein the instructions, when executed, further cause the apparatus to:
determine, when the first projectile generates the ricochet effect on the virtual item, that a quantity of ricochets of the first projectile increases by a first numerical value,
the quantity of ricochets of the first projectile being less than or equal to a specified quantity, and the first projectile that generates the ricochet effect on the virtual item being allowed to collide again with another virtual item in the virtual environment.

18. A non-transitory computer-readable medium storing computer-readable instructions that, when executed, cause an apparatus to:
display a computer-generated virtual environment, the virtual environment comprising a virtual shooting prop;
detect an operation on the virtual shooting prop;
control, in response to detecting the operation on the virtual shooting prop, the virtual shooting prop to release at least one projectile into the virtual environment, the at least one projectile including a first projectile;
determine whether the first projectile collides with a virtual item in the virtual environment;
determine whether the virtual item satisfies a ricochet condition; and
generate and display, in response to determining that the first projectile among the at least one projectile collides with the virtual item in the virtual environment, and the virtual item satisfies the ricochet condition, a ricochet effect of the first projectile generated on the virtual item, the ricochet condition being a condition required for generating the ricochet effect.

19. The non-transitory computer-readable medium according to claim 18, wherein the ricochet condition comprises at least one of the following:
a material of the virtual item belongs to a material of a specified category;
a quantity of ricochets of the first projectile is less than a specified quantity;
the virtual environment belongs to a virtual environment of a specified category; or
the virtual shooting prop belongs to a virtual shooting prop of a specified category.

20. The non-transitory computer-readable medium according to claim 18, wherein the instructions, when executed, further cause the apparatus to:
determine a ricochet probability based on the first projectile and the virtual item, the ricochet probability being configured for characterizing a probability that the first projectile generates the ricochet effect on the virtual item;
generate a random factor based on the ricochet probability; and
perform, when the random factor indicates that the first projectile generates the ricochet effect on the virtual item, the step of generating and displaying a ricochet effect of the first projectile generated on the virtual item.
